(19) United States
(12) Patent Application Publication
(10) Pub. No.: US 2016/0196740 A1
(43) Pub. Date: Jul. 7, 2016

(54) APPARATUS AND METHOD FOR AUTO-PAIRING OF REMOTE CONTROLLER USING NFC TAG

(71) Applicant: PACHEM KOREA CO., LTD., Seoul (KR)

(72) Inventor: Rhae Kwon PARK, Seoul (KR)

(73) Assignee: PACHEM KOREA CO., LTD., Seoul (KR)

(21) Appl. No.: 14/915,726

(22) PCT Filed: Sep. 3, 2014
(86) PCT No.: PCT/KR2014/008241

§ 371 Date: Mar. 1, 2016

(30) Foreign Application Priority Data
Sep. 6, 2013 (KR) 10-2013-0107220

(51) Int. Cl. G08C 17/02; H04W 4/00; H04B 5/00

(52) U.S. Cl. CPC G08C 17/02; H04B 5/0031; H04W 4/008; G08C 2201/20; G08C 2201/61

(57) ABSTRACT

Provided are an apparatus and a method for auto-pairing of a remote controller using an NFC tag. In the NFC tag, a flag indicating whether to pair the NFC tag, identification information of the remote controller and security information are stored and transmitted to an NFC receiver of a controlled device upon tagging. The controlled device enters a pairing mode according to the value of the flag and the identification information of the remote controller and returns a confirmation signal. The remote controller, which receives the confirmation signal, also enters a pairing mode. In this state, the controlled device requests pairing from the remote controller in an RF communication manner, and pairing is established through an automatic authentication process.

### TECHNICAL FIELD

The present invention disclosed herein relates to a remote controller technology field.

### BACKGROUND ART

A remote controller is used to wirelessly manipulate various kinds of electric appliances.

For communication between a remote controller and an electric appliance to be controlled, infra-red frequency and radio frequency and the like are being widely used. In spite of low cost, the infra-red is gradually disappearing due to short communication distance and reduction of the receiving rate by obstacles.

Meanwhile, it is general that these remote controllers are released while frequencies and device coded for communication with electric appliances to be controlled are preset.

However, when a remote controller is not set so as to be communicable with a specific electric appliance, a user needs to undergo a process of pairing the remote controller and the electric appliance in order to operate a desired electric appliance.

In regard to a typical paring process for a well-known remote controller, a user first pushes a pairing button of an electric appliance, and then waits for the electric appliance to recognize the remote controller. Thereafter, when the electric appliance recognizes the remote controller and a character string (or numerals) is displayed on the display screen, a user inputs the character string into the remote controller to perform pairing.

The inputting of the character string upon pairing is for strengthening security, and may be omitted under a situation where security is not needed.

When pairing needs to be frequently performed, for example, when pairing is alternately performed on different electric appliances, it is inevitably very inconvenient to perform a series of these processes.

Accordingly, development of a technology that enables simpler pairing and furthermore omission of a process such as password input for security is needed.

### DISCLOSURE

### Technical Problem

1. The present invention provides a method for simply performing pairing only with tagging using an NFC tag when a remote controller is selectively paired with a plurality of electric appliances.

2. The present invention also provides a method of calling out a certain function using Radio Frequency (RF) communication, by allowing an electric appliance and a remote controller to recognize that the remote controller and the electric appliance are paired with each other when performing NFC tagging with the electric appliance which is already paired with the remote controller.

3. The present invention also provides a method of removing existing pairing and establishing new pairing, by allowing an electric appliance and a remote controller to recognize that the remote controller and an existing electric appliance are paired with each other upon NFC tagging with the electric appliance when the remote controller is paired with the existing electric appliance.

### Technical Solution

In one general aspect, a method for auto-pairing of a remote controller using a Near Field Communication (NFC) tag includes:

a-1) recording pairing data including at least one of identification information, a flag indicating whether or not pairing is performed, and security information of the remote controller in the NFC tag when power is applied to the remote controller;

b-1) receiving, by the controlled device, the pairing data from the NFC tag via the NFC receiver as tagging occurs;

b-2) checking, by the controlled device, a value of the flag which indicates whether or not pairing is performed;

b-21) entering, by the controlled device, a pairing mode by a Radio Frequency (RF) method and transmitting a confirmation signal to the NFC tag via the NFC receiver when the flag has a value indicating that pairing is not performed;

a-2) entering, by the remote controller, the pairing mode by the RF communication;

b-4) establishing, by the controlled device, pairing with the remote controller by the RF communication using the identification information of the remote controller and performing authentication using the received security information; and

a-3) setting, by the remote controller, the flag to a value indicating that pairing is performed and recording identification information of the controlled device which is received in the pairing process in the NFC tag.

In another general aspect, a method for auto-pairing of a remote controller using a Near Field Communication (NFC) tag includes:

a-1) recording pairing data including at least one of identification information, a flag indicating whether or not pairing is performed, and security information of the remote controller in the NFC tag when power is applied to the remote controller;

b-1) receiving, by the controlled device, the pairing data from the NFC tag via the NFC receiver as tagging occurs;

b-2) checking, by the controlled device, a value of the flag, which indicates whether or not pairing is performed, from the pairing data;

b-3) checking, by the controlled device, whether or not controlled device identification information paired from the pairing data matches the identification information of the controller device when the flag has a value indicating that pairing is performed;

b-31) when the identification information of the controlled device does not matches the identification information of the existing paired controlled device, entering, by the controlled device, the pairing mode by the RF communication, and transmitting a confirmation signal to the NFC tag via the NFC receiver;

a-2) entering, by the remote controller, the pairing mode for the RF communication;

b-4) establishing, by the controlled device, pairing with the remote controller by the RF communication using the identification information of the remote controller and performing authentication using the received security information; and

a-3) deleting, by the remote controller, the controlled device identification information that is already recorded and recording the received identification information of the controlled device in the NFC tag.

In another general aspect, a method for auto-pairing of a remote controller using a Near Field Communication (NFC) tag includes:

c-1) transmitting pairing data including at least one of a flag indicating whether or not pairing is performed and identification information of the remote controller from the NFC tag to an NFC receiver of a controlled device upon tagging with the NFC receiver;

c-2) receiving a confirmation signal from the controlled device;

c-3) entering, by the remote controller, a pairing mode for RF communication as the confirmation signal is received;

c-4) establishing pairing as the controlled device makes a request for pairing by the RF communication using the identification information of the remote controller; and

c-5) storing, by the remote controller, the received identification information of the controlled device in pairing data stored in the NFC tag.

In another general aspect, an apparatus for auto-pairing of a remote controller using a Near Field Communication (NFC) tag includes:

an NFC tag storing pairing data including at least one of identification information, a flag indicating whether or not pairing is performed, and security information of the remote controller (100);

an Radio Frequency (RF) unit communicating with a controlled device by an RF communication; and

a control unit processing pairing with the controlled device by the RF communication.

Here, the paring data is transmitted from the NFC tag upon tagging with an NFC receiver of the controlled device, and when the NFC tag receives a confirmation signal from the controlled device,

the control unit enters a pairing mode by the RF communication, establishes pairing as the controlled device requests pairing by the RF communication using the identification information of the remote controller, and stores identification information of the controlled device in the NFC tag.

Other features and aspects will be apparent from the following detailed description, the drawings, and the claims.

### Advantageous Effects

According to an embodiment of the present invention, pairing can be established by a Radio Frequency (RF) method, only with simple tagging with an electric appliance to be paired.

Particularly, even when a remote controller is paired with an existing different electric appliance, an electric appliance and the remote controller can recognize that the existing different electric appliance and the remote controller are paired with each other, and thus existing pairing can be deleted and then new pairing can be established.

In addition, when tagging is performed with an existing electric appliance with which a remote controller is paired, data can be exchanged by a predetermined method, e.g., an RF communication, thereby enabling simple calling of additional functions.

### DESCRIPTION OF DRAWINGS

FIG. 1 is a view illustrating a process of tagging a remote controller and a controlled device.

FIG. 2 is a view illustrating a structure of an apparatus for auto-pairing of a remote controller using an NFC tag according to an embodiment of the present invention.

FIG. 3 is a flowchart illustrating a method for auto-pairing of a remote controller using an NFC tag according to an embodiment of the present invention.

FIG. 4 is a flowchart illustrating a data transmission/reception process between a remote controller and a controlled appliance according to an embodiment of FIG. 4.

FIG. 5 is a flowchart illustrating a method for auto-pairing of a remote controller using an NFC tag in terms of a remote controller according to an embodiment of the present invention.

### BEST MODE

Hereinafter, exemplary embodiments of the present invention will be described in detail with reference to the accompanying drawings. In order to clarify the present invention, a description irrelevant to the constitution of the present invention will be omitted, and in the drawings, like reference numerals refer to like elements throughout.

Since the terms “including”, “including”, and “having” can be construed as encompassing corresponding components unless specially described as opposite, it should be understood that they do not exclude other components but encompass other components. Unless defined otherwise, all technical and scientific terms have the same meanings as commonly understood by those skilled in the art to which the present invention belongs.

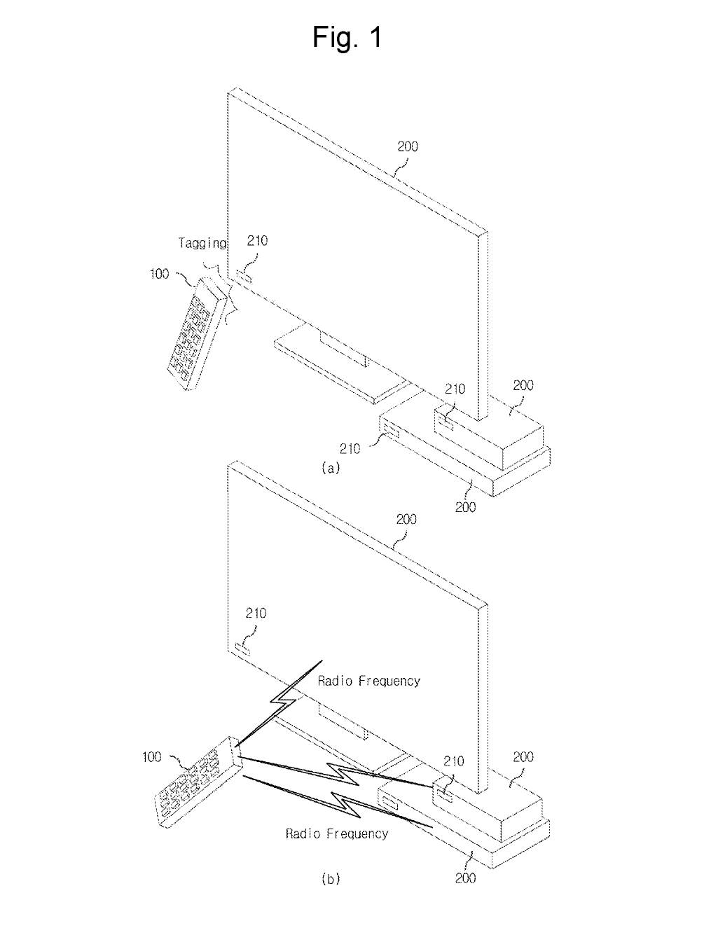

In the detailed description of the invention and claims, components named as “unit”, “˜part”, “˜module”, and “block” mean units that process at least one function or operation, and each of which can be implemented by software, hardware, or a combination thereof. FIG. 1 is a view illustrating a process of tagging a remote controller and a controlled device.

FIG. 1 shows a remote controller 100 and a plurality of controlled devices 200.

The remote controller 100 may control any one of the controlled devices 200 in which pairing is established by a Radio Frequency (RF) method.

The controlled device 200 may operate in accordance with information received from the remote controller 100 through RF, and may include home appliances such as home TVs, set-top boxes, and DVD players, and various kinds of office or industrial electronic and electric appliances.

In this case, the remote controller 100 may be provided with a Near Field Communication (NFC) tag, and the controlled device 200 may include an NFC receiver 210.

That is, the remote controller 100 and the controlled device 200 may communicate with each other by two methods, e.g., NFC and RF communications.

On the other hand, in order to pair the remote controller 100 with one of the controlled devices 200, a user may first bring the remote controller 100 into contact or close proximity with the NFC receiver 210 of the controlled device 200 as shown in (a) of FIG. 1.

Accordingly, the NFC receiver 210 of the controlled device 200 may receive information from the NFC tag of the remote controller 100, and may enter a pairing mode by the RF communication and then return a confirmation signal.

The remote controller 100 that receives the confirmation signal may wait for a pairing request from the controlled device 200, and may exchange certain information necessary for pairing with the controlled device 200 to establish pairing.

Protocols and procedures for pairing and required data may be standardized in accordance with the communication method. For example, in case of the communication method such as Zigbee or RF4CE, standards for pairing may be predetermined, and the remote controller 100 and the controlled device 200 may be paired in accordance with standards predetermined depending on an RF communication system that is adopted.

After pairing is performed, a user may control the controlled device 200, pairing of which has been established using the remote controller 100, by the RF communication system.

That is, pairing may start by tagging the NFC tag provided on the remote controller 200 to the NFC receiver 210 of the controlled device 200, and thereafter, the controlled device 200 may be controlled by the RF communication system.

An apparatus for auto-pairing of a remote controller using an NFC tag according to an embodiment of the present invention enables a series of these processes.

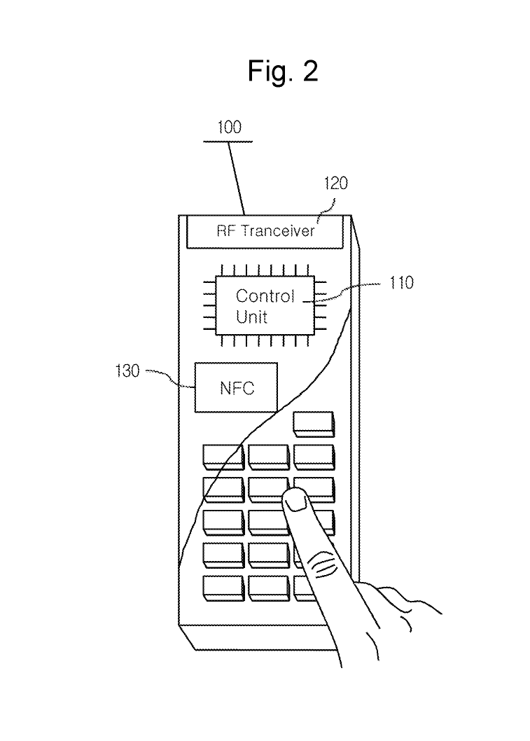

FIG. 2 is a view illustrating a structure of an apparatus for auto-pairing of a remote controller using an NFC tag according to an embodiment of the present invention.

The apparatus for auto-pairing of a remote controller using an NFC tag according to an embodiment of the present invention may be implemented in a form of the remote controller 100.

As shown in FIG. 2, the remote controller 100 may include a control unit 110, an RF communication unit, and an NFC tag 130. In addition, the remote controller 100 may further include a battery, a memory, and buttons, which are general components of a well-known remote controller.

The control unit 110 may control pairing with the controlled device 200 by the RF communication.

The RF communication unit 120 may correspond to a unit for transmitting or receiving a radio frequency. The RF communication unit 120 may be a wireless communication adapter complying with standards such as Zigbee or RF4CE.

The NFC tag 130 may store pairing data.

The pairing data may include identification information of the remote controller 100, a flag indicating pairing or not, security information, and identification information of the controlled device 200.

When the remote controller 100 operates for the first time through the battery charged or inserted, the control unit 100 may fetch the identification information and security information of the remote controller 100 from a Read Only Memory (ROM) or non-volatile memory to generate pairing data by a certain data structure and record the pairing data in the NFC tag 130.

In this case, since pairing is not yet performed, the flag indicating paring or not may be set to “False” or “0”. That is, a value indicating that pairing is not established may be set.

Meanwhile, since the flag is “False”, the identification information of the controlled device 200 in which pairing is already performed may not be recorded.

The pairing data may merely denote data including at least one of identification information of the remote controller 100, a flag indicating pairing or not, security information, and identification information of the controlled device 200, and these data need not be processed into a specific data structure and be continuously stored in a storage space of the NFC tag 230.

Thus, if a user brings the remote controller 100 into contact or close proximity to the NFC receiver 210 of the controlled device 200 after the remote controller 10 operates for the first time and then the pairing data is recorded in the NFC tag 230, the controlled device 200 may read the pairing data.

The controlled device 200 may enter the pairing mode when the flag is “False”, and may return a confirmation signal.

The NFC tag 130 may generate an interrupt signal to the control unit 110 upon tagging, and then may inform the control unit 110 of the confirmation signal when receiving the confirmation signal.

Accordingly, the control unit 110 may enter the pairing mode, and may wait for a pairing request of the controlled device 200 through the RF communication unit 120.

The controlled device 200 may make a request for pairing using the identification information of the remote controller 100 which is received.

The identification information of the remote controller 100 may correspond to information for identifying the remote controller 100 upon pairing, and may be set for each RF communication standard. For example, the identification information may be a MAC address.

On the other hand, the control nit 110 may make a request for security information via RF communication in accordance with the pairing request from the controlled device 200.

The controlled device 200 may transmit the security information obtained from the pairing data received upon NFC tagging to the RF communication unit 120 of the remote controller 100.

The control unit 110 may establish the pairing when the security information that is received matches the security information stored in the NFC tag 130.

In this case, the security information may be information for strengthening the security upon pairing, and may correspond to the information including a character string or a digit string.

According to a well-known technology, a user may input a password, for example, may typically push a keypad displayed on a screen of any one of two devices to be paired.

When pairing is performed through this process, the controlled device 200 may transmit its own identification information to the RF communication unit 120 of the remote controller 100 via the RF communication system.

As pairing is performed, the control unit 110 may set the flag to “TRUE” or “1”. That is, a value indicating that pairing is established may be set.

Also, the identification information of the controlled device 200 which is received may be stored in the NFC tag 130.

That is, as pairing is established, the flag value of the pairing data stored in the NFC tag 130 and the identification information of the controlled device 200 may be updated.

As described later, when pairing is performed on another controlled device 200 while being paired with one of controlled devices, the flag value may be maintained at “TRUE”, but the identification information of the controlled device 200 may be deleted and then overwritten by the identification information of the controlled device 200 which is newly paired.

That is, a user can operate one of a plurality of controlled devices 200 using the remote controller 100, by pairing the remote controller 100 and the controlled device 200 that is owned and desired by the user.

### Example 1

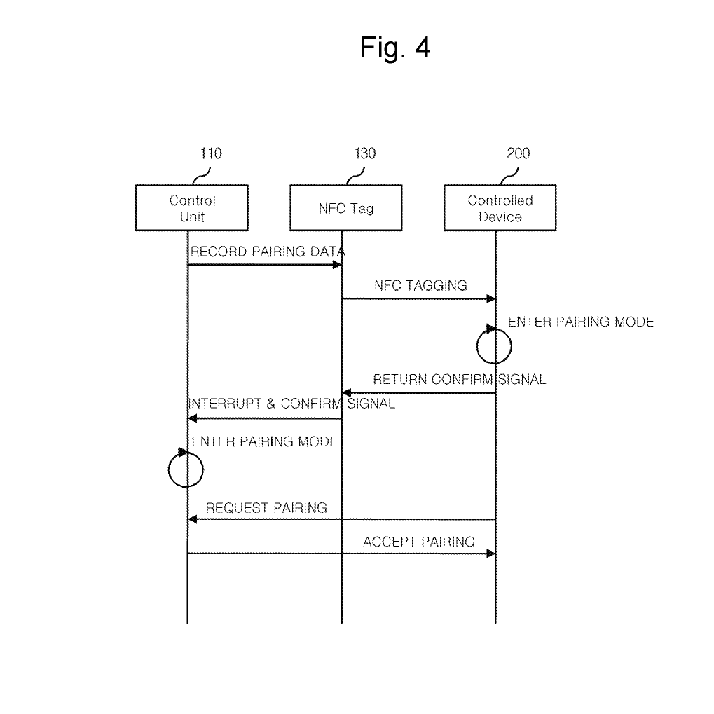

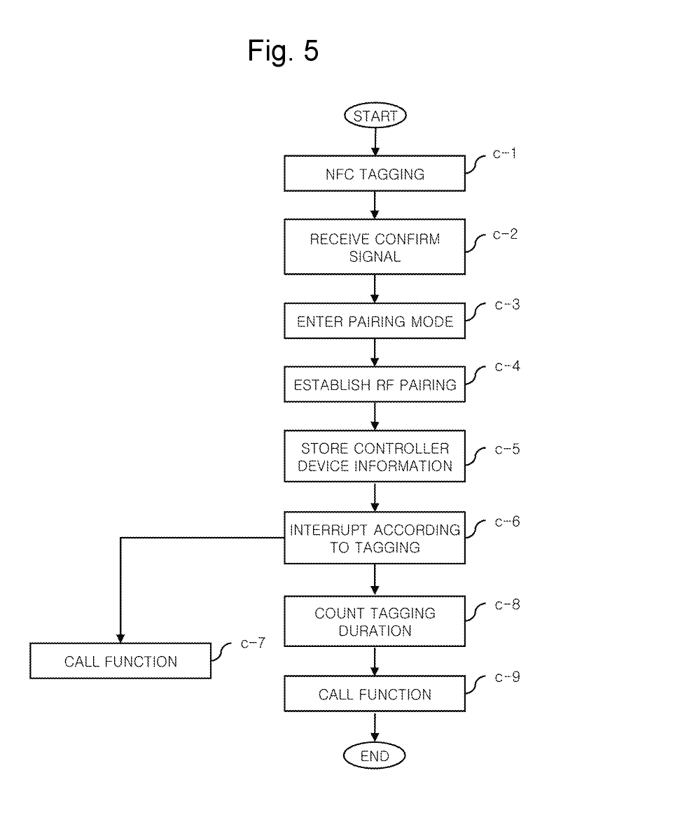

Hereinafter, a method for auto-pairing of a remote controller using an NFC tag according to an embodiment of the present invention will be described in detail with reference to FIGS. 4 and 5.

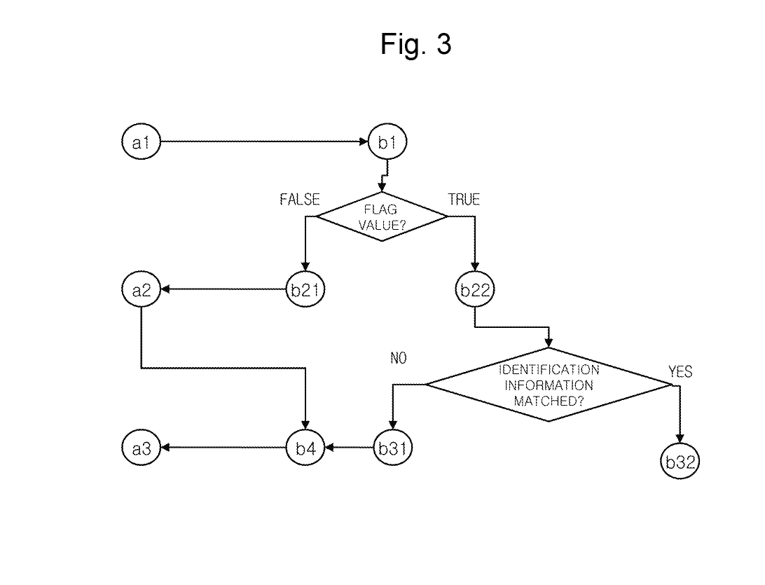

FIG. 3 is a flowchart illustrating a method for auto-pairing of a remote controller using an NFC tag according to an embodiment of the present invention, and FIG. 5 is a flowchart illustrating a data transmission/reception process between a remote controller and a controlled appliance.

The present invention illustrated in FIGS. 4 and 5 may be executed in the remote controller 100 including the NFC tag 130 and the controlled device 200 including the NFC receiver 210.

When power is applied to the remote controller 100 and the remote controller 100 operates for the first time, the remote controller 100 may record pairing data in the NFC tag 130 (operation a-1).

In this case, the pairing data may include identification information of the remote controller 100, a flag indicating pairing or not, and security information.

Meanwhile, when a user brings the remote controller 100 into contact or close proximity to the NFC receiver 210 of the controlled device 200, i.e., when a user tags the remote controller 100 to the NFC receiver 210, the controlled device 200 may read out pairing data from the NFC tag 130 through the NFC receiver 210 (operation b-1).

Thereafter, the controlled device 200 may check a value of the flag which indicates whether or not pairing is performed (operation b-2).

In this case, when the flag value is “FALSE”, i.e., a value indicating that pairing is not established, the controlled device 200 may enter the pairing mode, and may return a confirmation signal (operation b-21).

When the remote controller 100 receives the confirmation signal, the remote controller 100 may enter the pairing mode by an RF communication (operation a-2).

That is, the remote controller 100 and the controlled device 200 may both enter the pairing mode.

Thereafter, the controlled device 200 may identify the remote controller 100 by the RF communication using the identification information of the remote controller 100, and may transmit a pairing request signal to the RF communication unit 120 of the remote controller 100 that is identified.

Accordingly, the remote controller 100 may request security information from the controlled device 200 through RF communication.

Also, as the controlled device 200 returns the received security information, the remote controller 100 may check whether or not the returned security information matches the security information stored in the NFC tag 230, and may accept pairing when the returned security information matches the security information stored in the NFC tag 230.

Pairing may be established by a series of these processes (operation b4).

On the other hand, as pairing is established, the remote controller 100 may set the flag to “TRUE”, i.e., a value indicating that pairing was performed.

Also, the identification information of the controlled device 200 which is received in the pairing process may be recorded in the NFC tag 130 (operation a-3).

Thus, the pairing process may be finished.

On the other hand, when the flag value is “TRUE”, i.e., a value indicating pairing is established in operation b-2, the controlled device 200 may fetch controlled device identification information from the pairing data (operation b-22).

When the flag value is “TRUE”, the procedure may be again divided into the following two cases.

The first may correspond to a case where the remote controller 100 is already paired with the very controlled device 200 that is tagged.

The second may correspond to a case where the remote controller 100 is being paired with another controlled device 200.

When the flag value is “TRUE”, the controlled device 200 may fetch the identification information of an existing paired controlled device from the pairing data, and may check whether or not the identification information matches its own identification information.

In this case, the case where the identification information of the controlled device 200 does not match the identification information of the existing paired controlled device may correspond to the first case.

When the identification information of the controlled device 200 does not matches the identification information of the existing paired controlled device, the controlled device 200 may enter the pairing mode by the RF communication, and may transmit a confirmation signal to the NFC tag 130 via the NFC receiver 210 (operation b-31).

As the confirmation signal is transmitted, the remote controller 100 may branch into operation a-2, and may enter the pairing mode.

Also, the controlled device 200 may branch into operation b-4, and may request pairing from the remote controller 100 by the RF communication using the identification information of the remote controller 100.

The subsequent pairing process may be the same as described above.

On the other hand, the case where the identification information of the existing paired controlled device matches its own identification information may correspond to the second case.

In this case, since the controlled device 200 and the remote controller 100 are already paired with each other, a separate confirmation signal may not be transmitted via NFC.

As tagging occurs, the NFC tag 130 may generate an interrupt to the control unit 110. Nevertheless, since a confirmation signal informing that the controlled device 200 entered the pairing mode is not transmitted, the remote controller 100 may recognize that the tagging is tagging with the controlled device 200 in which pairing is already established.

That is, the controlled device 200 and the remote controller 100 may recognize that tagging was performed on the counterpart in which pairing is already established.

In this case, the controlled device 200 may execute a certain function by tagging (operation b32).

For example, when tagging occurs in a state where a sleep mode is being executed, the controlled device 200 may finish the sleep mode.

In addition, various functions may be preset so as to be executable upon tagging of the remote controller 100 in which pairing is established.

### Example 2

Hereinafter, one aspect of a method for auto-pairing of a remote controller using an NFC tag according to an embodiment of the present invention will be described in detail with reference to FIG. 5.

FIG. 5 is a flowchart illustrating a method for auto-pairing of a remote controller using an NFC tag in terms of a remote controller 100 according to an embodiment of the present invention.

That is, the present invention shown in FIG. 5 may be executed in the remote controller 100.

When a user brings the remote controller 100 into contact or close proximity to the NFC receiver 210 and thus tagging occurs between the NFC tag 130 and the NFC receiver 210, pairing data may be transmitted from the NFC tag 130 to the NFC receiver 210 of the controlled device 200 (operation c-1).

On this other hand, as described in the above-mentioned embodiment, when the controlled device 200 enters the pairing mode through the processes according to the flag values, the remote controller 100 may receive a confirmation signal from the controlled device 200 (operation c-2).

As the confirmation signal is received, the remote controller 100 may enter the pairing mode for RF communication (operation c-3).

Thereafter, as the controlled device 200 makes a request for pairing by an RF communication using the identification information of the remote controller 100, pairing may be established (operation c-4).

In this case, if necessary, security information may be requested from the controlled device 200. When a return value matches the security information stored in the NFC tag 130, pairing may also be accepted.

Also, when pairing is established, the identification information of the controlled device 200 which is received in the pairing process may be stored in the NFC tag 130 (operation c-5).

In this case, when identification information of another controlled device other than the identification information of the controlled device 200 that is received already exists, the existing identification information may be deleted, and then the identification information that is received may be stored.

That is, existing pairing may be deleted, and new pairing with the controlled device 200 may be established.

On the other hand, when a user again performs tagging while pairing with the controlled device 200 exists, the procedure may proceed as follows.

First, when tagging with the NFC receiver 210 is performed, the NFC tag 130 may generate an interrupt to the control unit 110 (operation c-6).

If the remote controller 100 is operating in the sleep mode, the control unit 110 may perform an operation such as finishing the sleep mode (operation c-7).

Thus, in addition to executing a specific operation by single tagging, it may also be possible to execute the specific operation when tagging is performed for a certain time.

That is, in operation c-6, when a user brings the remote controller 100 into close proximity to the NFC receiver 210 of the controlled device and stays for a certain time, the NFC tag 130 may periodically generate an interrupt while tagging lasts.

When the interrupts are generated, the control unit 110 may count the number of interrupts to calculate the tagging duration (operation c-8).

When the tagging duration reaches a certain value, the remote controller 100 may perform a predetermined function (operation c-9).

For example, the remote controller 100 may exchange data with the controlled device 200 by RF communication in accordance with a predetermined condition.

Information on the battery state and firmware version of the remote controller 100 may be transmitted to the controlled device 200 via RF communication, and the controlled device 200 may display the information on the screen.

The method for auto-pairing of the remote controller using the NFC tag according to the embodiment of the present invention may be embodied in a form of software that is a set of computer readable commands, and may be recorded in a recording medium.

In this case, the recording medium can include all kinds of media which can be thereafter read by a computer. Examples of the recording medium include materials such as DVD-Read Only Memories (DVD-ROMs), CD-ROMs, hard disks, USB memories, and flash memories.

On the other hand, the expression, being recorded in a recording medium, includes being provided in a form of intangible carrier wave through a communication line, as well as being recorded in a tangible recording medium described above.

Although the present invention has been described with reference to the accompanying drawings and the above embodiments, those skilled in the art will appreciate that various modifications and other equivalent embodiments are possible from the above embodiments.

### INDUSTRIAL APPLICABILITY

The present invention can be applied to a remote controller technical field.

1. A method for auto-pairing of a remote controller using a Near Field Communication (NFC) tag, which is executed in the remote controller comprising the NFC tag and a controlled device comprising an NFC receiver, the method comprising:
recording pairing data comprising at least one of identification information, a flag indicating whether or not pairing is performed, and security information of the remote controller (100) in the NFC tag (130) when power is applied to the remote controller (100);
receiving, by the controlled device (200), the pairing data from the NFC tag (130) via the NFC receiver (210) as tagging occurs;
checking, by the controlled device (200), a value of the flag which indicates whether or not pairing is performed;
entering, by the controlled device (200), a pairing mode by a Radio Frequency (RF) method and transmitting a confirmation signal to the NFC tag (130) via the NFC receiver (210) when the flag has a value indicating that pairing is not performed;
entering, by the remote controller (100), the pairing mode by the RF communication;
establishing pairing by performing authentication, by allowing the controlled device (200) to request pairing with the remote controller (100) by the RF communication using the identification information of the remote controller (100) and by transmitting the received security information to the controlled device (200); and
setting, by the remote controller (100), the flag to a value indicating that pairing is performed and recording identification information of the controlled device (200) which is received in the pairing process in the NFC tag (130),
wherein after the checking of the value of the flag, the method further comprises performing a predetermined operation and finishing the procedure instead of entrance of the controlled device (200) or the remote controller (100) to the pairing mode when the pairing data comprise the identification information of the controlled device (200).

2. A method for auto-pairing of a remote controller using a Near Field Communication (NFC) tag, which is executed in the remote controller comprising the NFC tag and a controlled device comprising an NFC receiver, the method comprising:
receiving, by the controlled device (200), the pairing data from the NFC tag (130) via the NFC receiver (210) as tagging occurs;
checking, by the controlled device (200), a value of the flag, which indicates whether or not pairing is performed, from the pairing data;
further checking, by the controlled device (200), whether or not controlled device identification information comprised in the pairing data matches the identification information of the controller device (200) when the flag has a value indicating that pairing is performed, and performing a predetermined operation and finishing the procedure instead of entrance to the pairing mode when the controlled device identification information matches the identification information of the controller device (200);
entering, by the controlled device (200), the pairing mode by a Radio Frequency (RF) method and transmitting a confirmation signal to the NFC tag (130) via the NFC receiver (210) when the flag has a value indicating that pairing is not performed or when the controlled device identification information comprised in the pairing data does not match the identification information of the controller device (200); and
establishing pairing by performing authentication, by allowing the controlled device (200) to request pairing with the remote controller (100) by the RF communication using the identification information of the remote controller (100) and by transmitting security information comprised in the pairing data to the controlled device (200).

3. A method for auto-pairing of a remote controller using a Near Field Communication (NFC) tag, which is executed in the remote controller comprising the NFC tag, the method comprising:
transmitting pairing data comprising at least one of a flag indicating whether or not pairing is performed and identification information of the remote controller (100) from the NFC tag (130) to an NFC receiver (210) of a controlled device (200) upon tagging with the NFC receiver (210);
receiving a confirmation signal from the controlled device (200);
entering, the remote controller (100), a pairing mode by a Radio Frequency (RF) method as the confirmation signal is received from the controlled device (200);
establishing pairing as the controlled device (200) makes a request for pairing by the RF communication using the identification information of the remote controller (100); and
receiving, by the remote controller (100), receiving identification information of the controlled device (200) and storing the identification information of the controlled device (200) in the NFC tag (130),
wherein after the receiving of the confirmation signal from the controlled device (200),
the method further comprises performing a predetermined operation and finishing the procedure instead of entrance of the remote controller (100), which does not receive the confirmation signal from the controlled device (200), to the pairing mode when the controlled device (200) confirms already-established pairing with the remote controller (100) and thus does not transmit the confirmation signal.

4. The method of claim 3, wherein the establishing of the pairing comprises:
requesting security information of the controlled device (200) as the controlled device (200) makes a request for pairing by the RF communication using the identification information of the remote controller (100); and
accepting pairing with the controlled device (200) when the security information inputted from the controlled device (200) matches security information stored in the pairing data of the NFC tag (130).

5. The method of the claim 3, wherein in the storing of the identification information of the controlled device (200),
when identification information of another controlled device other than the identification information of the controlled device (200) exists in the pairing data stored in the NFC tag (130), the existing identification information is deleted, and then the identification information that is received is stored.

6. The method of the claim 3, after the storing of the identification information of the controlled device (200), further comprising:
periodically generating, by the NFC tag (130), an interrupt while tagging with the NFC receiver (210) lasts;
calculating, by the remote controller (100), a tagging duration from the interrupt; and
exchanging, by the remote controller (100), data with the controlled device (200) in accordance with a predetermined condition when the tagging duration reaches a certain value.

7. An apparatus for auto-pairing of a remote controller using a Near Field Communication (NFC) tag, the remote controller comprising:
an NFC tag (130) storing pairing data comprising at least one of identification information, a flag indicating whether or not pairing is performed, and security information of the remote controller (100);
an Radio Frequency (RF) unit (120) communicating with a controlled device (200) by an RF communication; and
a control unit (110) processing pairing with the controlled device (200) by the RF communication,
wherein:
the paring data is transmitted from the NFC tag (130) upon tagging with an NFC receiver (210) of the controlled device (200);
when the NFC tag (130) receives a confirmation signal from the controlled device (200), the control unit (110) enters a pairing mode by the RF communication, establishes pairing as the controlled device (200) requests pairing by the RF communication using the identification information of the remote controller (100), and stores identification information of the controlled device (200) in the NFC tag (130); and
the control unit (110) which does not receive a confirmation signal from the controlled device (200) via the NFC tag (130) performs a predetermined operation instead of entrance to the pairing mode by the RF communication when the controlled device (200) confirms already-established pairing with the remote controller (100) and thus does not transmit the confirmation signal.
